(19) United States
(12) Patent Application Publication
(10) Pub. No.: US 2025/0106607 A1
(43) Pub. Date: Mar. 27, 2025

(54) IN-VEHICLE DEVICE, MANAGEMENT DEVICE, TRANSMISSION PATH AUTHENTICATION SYSTEM, TRANSMISSION PATH AUTHENTICATION METHOD, AND MANAGEMENT METHOD

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Toshihiro ICHIMARU, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/730,865

(22) PCT Filed: Nov. 22, 2022
(86) PCT No.: PCT/JP2022/043091

§ 371 Date: Jul. 22, 2024

(30) Foreign Application Priority Data
Jan. 24, 2022 (JP) 2022-008528

(51) Int. Cl. H04W 4/48; B60R 16/023; H04L 67/12; H04W 12/06

(52) U.S. Cl. CPC H04W 4/48; B60R 16/023; H04L 67/12; H04W 12/06

(57) ABSTRACT

An in-vehicle device mounted to a vehicle includes: a storage unit configured to store characteristic data indicating a characteristic of a transmission path in an in-vehicle network mounted to the vehicle; a measurement unit configured to measure the characteristic of the transmission path; and an authentication unit configured to perform an authentication process for the transmission path by using a comparison result between the characteristic data in the storage unit and a measurement result by the measurement unit.

This application claims priority on Japanese Patent Application No. 2022-8528 filed in Japan on Jan. 24, 2022, the entire contents of which are incorporated herein by reference.

### TECHNICAL FIELD

The present disclosure relates to an in-vehicle device, a management device, a transmission path authentication system, a transmission path authentication method, and a management method.

### BACKGROUND ART

PATENT LITERATURE 1 (International Publication No. WO2015/052879) discloses a distortion compensation system as below. That is, the distortion compensation system includes: a first communication node (4, 104, 204) including a first reception unit (13, 113) including an equalizer (12, 112) configured by using a first digital filter (FF1, FB1, FF101), and a first transmission unit (10, 110) including an emphasis circuit (8, 108) configured by using a second digital filter (FF2, FB2, FF102); and a second communication node (5, 105, 205a) including a second transmission unit (23) configured to transmit, through a first transmission line (6, 6a, 206a) to the first communication node, a training pattern determined in advance before receiving normal data from the first transmission unit of the first communication node. The first communication node is configured to receive, by means of the first reception unit, the training pattern transmitted by the second transmission unit of the second communication node. The equalizer converges a filter constant of the first digital filter so that an error with respect to the training pattern can be converged to be received. The first transmission unit of the first communication node performs distortion compensation on the normal data using the converged filter constant of the first digital filter as at least a part of a filter constant of the second digital filter of the emphasis circuit, and transmits the resultant normal data.

PATENT LITERATURE 2 (Japanese Laid-Open Patent Publication No. 2020-174228) discloses a high-speed signal transmission device as below. That is, the high-speed signal transmission device includes, for each transmission channel: a reception circuit unit that receives a signal from another high-speed signal transmission device; and a transmission circuit unit that transmits a signal to the other high-speed signal transmission device. The transmission circuit unit transmits, to the other high-speed signal transmission device, a transmission parameter change request for incrementing or decrementing a transmission parameter of the other high-speed signal transmission device. The reception circuit unit sweeps a reception parameter every time the transmission parameter of the other high-speed signal transmission device is incremented or decremented, to measure a transmission signal quality, determines the transmission parameter of the other high-speed signal transmission device when the measured transmission signal quality has the best value, as the best value of the transmission parameter of the other high-speed signal transmission device, determines the reception parameter when the measured transmission signal quality has the best value, as the best value of the reception parameter, and sets the reception parameter to the best value of the reception parameter. The transmission circuit unit transmits, to the other high-speed signal transmission device, a transmission parameter change request for setting the transmission parameter of the other high-speed signal transmission device, to the best value of the transmission parameter of the other high-speed signal transmission device.

### CITATION LIST

### Patent Literature

PATENT LITERATURE 1: International Publication No. WO2015/052879
PATENT LITERATURE 2: Japanese Laid-Open Patent Publication No. 2020-174228

### SUMMARY OF THE INVENTION

An in-vehicle device of the present disclosure is mounted to a vehicle, and includes: a storage unit configured to store characteristic data indicating a characteristic of a transmission path in an in-vehicle network mounted to the vehicle; a measurement unit configured to measure the characteristic of the transmission path; and an authentication unit configured to perform an authentication process for the transmission path by using a comparison result between the characteristic data in the storage unit and a measurement result by the measurement unit.

A management device of the present disclosure includes: an acquisition unit configured to acquire characteristic data indicating a characteristic of a transmission path in an in-vehicle network mounted to a vehicle; and a transmission unit configured to transmit, to the vehicle, deterioration change information corresponding to the characteristic data acquired by the acquisition unit, the deterioration change information indicating a change tendency of the characteristic of the transmission path due to aged deterioration of the transmission path.

A transmission path authentication system of the present disclosure includes: a measurement device mounted to a vehicle; an authentication device; and a storage device. The storage device stores characteristic data indicating a characteristic of a transmission path in an in-vehicle network mounted to the vehicle. The measurement device measures the characteristic of the transmission path. The authentication device performs an authentication process for the transmission path by using a comparison result between the characteristic data in the storage device and a measurement result by the measurement device.

A transmission path authentication method of the present disclosure is performed in an in-vehicle device mounted to a vehicle. The in-vehicle device includes a storage unit configured to store characteristic data indicating a characteristic of a transmission path in an in-vehicle network mounted to the vehicle. The transmission path authentication method includes the steps of: measuring the characteristic of the transmission path; and performing an authentication process for the transmission path by using a comparison result between the characteristic data in the storage unit and a measurement result of the characteristic of the transmission path.

A management method of the present disclosure is performed in a management device, and includes the steps of: acquiring characteristic data indicating a characteristic of a transmission path in an in-vehicle network mounted to a vehicle; and transmitting, to the vehicle, deterioration change information corresponding to the acquired characteristic data, the deterioration change information indicating a change tendency of the characteristic of the transmission path due to aged deterioration of the transmission path.

One mode of the present disclosure can be realized not only as an in-vehicle device including such a characteristic processing unit, but also as a semiconductor integrated circuit that realizes a part or the entirety of the in-vehicle device, as a program for causing a computer to execute process steps in the in-vehicle device, or as a system including the in-vehicle device.

One mode of the present disclosure can be realized not only as a management device including such a characteristic processing unit, but also as a semiconductor integrated circuit that realizes a part or the entirety of the management device, or as a system including the management device.

### BRIEF DESCRIPTION OF DRAWINGS

FIG. 1 shows a configuration of a transmission path authentication system according to an embodiment of the present disclosure.

FIG. 2 shows an example of an in-vehicle network according to the embodiment of the present disclosure.

FIG. 3 shows a configuration of an in-vehicle device according to the embodiment of the present disclosure.

FIG. 4 shows an example of a deterioration prediction table stored in a storage unit in an in-vehicle device of the present disclosure.

FIG. 5 shows an example of a measurement result of insertion loss in a transmission path in an in-vehicle communication system according to the embodiment of the present disclosure.

FIG. 6 shows a configuration of a server according to the embodiment of the present disclosure.

FIG. 7 is a flowchart describing an example of an operation procedure when an in-vehicle device performs an authentication process for a transmission path according to the embodiment of the present disclosure.

FIG. 8 is a flowchart describing an example of an operation procedure when the server performs transmission of a deterioration prediction table.

FIG. 9 shows an example of a sequence of the authentication process performed in the transmission path authentication system according to the embodiment of the present disclosure.

FIG. 10 shows an example of a sequence of the authentication process performed in the transmission path authentication system according to the embodiment of the present disclosure.

### DETAILED DESCRIPTION

To date, various functions regarding transmission paths in in-vehicle networks have been developed.

### Problems to be Solved by the Present Disclosure

A technology that can realize excellent functionality regarding a transmission path in an in-vehicle network is desired beyond the technologies described in PATENT LITERATURES 1 and 2.

The present disclosure has been made in order to solve the problem described above. An object of the present disclosure is to provide an in-vehicle device, a management device, a transmission path authentication system, a transmission path authentication method, and a management method that can realize excellent functionality regarding a transmission path in an in-vehicle network.

### Effects of the Present Disclosure

According to the present disclosure, excellent functionality regarding a transmission path in an in-vehicle network can be realized.

### Description of Embodiment of the Present Disclosure

First, contents of an embodiment of the present disclosure are listed and described.

(1) An in-vehicle device according to the embodiment of the present disclosure is mounted to a vehicle and includes: a storage unit configured to store characteristic data indicating a characteristic of a transmission path in an in-vehicle network mounted to the vehicle; a measurement unit configured to measure the characteristic of the transmission path; and an authentication unit configured to perform an authentication process for the transmission path by using a comparison result between the characteristic data in the storage unit and a measurement result by the measurement unit.

In this configuration, the authentication process for the transmission path is performed by using a comparison result between the characteristic data in the storage unit and the measurement result of the characteristic of the transmission path. Therefore, various appropriate processes and the like corresponding to the result of the authentication process can be performed. For example, in a case where the authentication process has been performed at the time of activation of the in-vehicle device and the authentication process has been successful, if a process using fixed information corresponding to the authenticated transmission path is performed, the activation process that should be performed at the time of activation can be simplified. Therefore, the time required in the activation process of the in-vehicle device can be shortened. Therefore, excellent functionality regarding the transmission path in the in-vehicle network can be realized.

(2) In (1) above, the in-vehicle device may further include a communication unit configured to communicate with another in-vehicle device through the transmission path. The storage unit may further store a correction parameter to be used, in communication with the other in-vehicle device, by the communication unit. When the authentication process by the authentication unit has been successful, the communication unit may perform, by using the correction parameter in the storage unit, at least either one of correction of a reception signal received from the other in-vehicle device and correction of a transmission signal that should be transmitted to the other in-vehicle device.

With this configuration, for example, in a case where the authentication process has been performed at the time of activation of the in-vehicle device and the authentication process has been successful, communication with the other in-vehicle device can be started by using the correction parameter determined in advance. Therefore, as compared with a configuration in which the correction parameter is re-calculated every time the in-vehicle device is activated, the time required in the activation process of the in-vehicle device can be shortened. In addition, as compared with a configuration in which the correction parameter is re-calculated every time the in-vehicle device is activated, an appropriate correction parameter can be stably used, and thus, communication with high quality and high reliability can be performed.

(3) In (1) or (2) above, the in-vehicle device may further include an abnormality processing unit capable of performing a predetermined abnormality process when the authentication process by the authentication unit has failed.

With this configuration, when an abnormality in the transmission path, a physical unauthorized access to the in-vehicle network, or the like has occurred, an appropriate process, such as notifying a user of the vehicle that the authentication process has failed, can be performed as the abnormality process.

(4) In (3) above, the abnormality processing unit may withhold the abnormality process when the authentication process by the authentication unit has failed and the authentication process by the authentication unit has been successful in the past.

With this configuration, for example, when the cause of the failure of the authentication process is aged deterioration of the transmission path, another appropriate process can be performed instead of the abnormality process.

(5) In (2) above, the storage unit may further store deterioration change information indicating a change tendency of the characteristic of the transmission path due to aged deterioration of the transmission path. The in-vehicle device may further include: a determination unit configured to determine, based on the measurement result by the measurement unit and the deterioration change information in the storage unit, whether or not a cause of failure of the authentication process is aged deterioration of the transmission path; and a setting unit configured to set a new correction parameter to be used, in communication with the other in-vehicle device, by the communication unit when it has been determined, by the determination unit, that the cause of the failure of the authentication process is aged deterioration of the transmission path.

With this configuration, when the cause of the failure of the authentication process is aged deterioration of the transmission path, communication with the other in-vehicle device can be performed by using a correction parameter that suits the current deterioration state of the transmission path.

(6) A management device according to the embodiment of the present disclosure includes: an acquisition unit configured to acquire characteristic data indicating a characteristic of a transmission path in an in-vehicle network mounted to a vehicle; and a transmission unit configured to transmit, to the vehicle, deterioration change information corresponding to the characteristic data acquired by the acquisition unit, the deterioration change information indicating a change tendency of the characteristic of the transmission path due to aged deterioration of the transmission path.

In this configuration, deterioration change information corresponding to the characteristic of the transmission path in the vehicle is transmitted to the vehicle. Therefore, for example, in an in-vehicle device that performs the authentication process for the transmission path by using a comparison result between the characteristic of the transmission path in the past and the characteristic of the transmission path at present, when the authentication process has failed, it is possible to determine, by using the deterioration change information, whether or not the cause of the failure of the authentication process is aged deterioration of the transmission path. Therefore, excellent functionality regarding the transmission path in the in-vehicle network can be realized.

(7) A transmission path authentication system according to the embodiment of the present disclosure includes: a measurement device mounted to a vehicle; an authentication device; and a storage device. The storage device stores characteristic data indicating a characteristic of a transmission path in an in-vehicle network mounted to the vehicle. The measurement device measures the characteristic of the transmission path. The authentication device performs an authentication process for the transmission path by using a comparison result between the characteristic data in the storage device and a measurement result by the measurement device.

In this configuration, the authentication process for the transmission path is performed by using a comparison result between the characteristic data in the storage device and the measurement result of the characteristic of the transmission path. Therefore, various appropriate processes and the like corresponding to the result of the authentication process can be performed. For example, in a case where the authentication process has been performed at the time of activation of the in-vehicle device to which the transmission path is connected and the authentication process has been successful, if a process using fixed information corresponding to the authenticated transmission path is performed, the activation process that should be performed at the time of activation can be simplified. Therefore, the time required in the activation process of the in-vehicle device can be shortened. Therefore, excellent functionality regarding the transmission path in the in-vehicle network can be realized.

(8) A transmission path authentication method according to the embodiment of the present disclosure is performed in an in-vehicle device mounted to a vehicle. The in-vehicle device includes a storage unit configured to store characteristic data indicating a characteristic of a transmission path in an in-vehicle network mounted to the vehicle. The transmission path authentication method includes the steps of: measuring the characteristic of the transmission path; and performing an authentication process for the transmission path by using a comparison result between the characteristic data in the storage unit and a measurement result of the characteristic of the transmission path.

In this method, the authentication process for the transmission path is performed by using a comparison result between the characteristic data in the storage unit and the measurement result of the characteristic of the transmission path. Therefore, various appropriate processes and the like corresponding to the result of the authentication process can be performed. For example, in a case where the authentication process has been performed at the time of activation of the in-vehicle device and the authentication process has been successful, if a process using fixed information corresponding to the authenticated transmission path is performed, the activation process that should be performed at the time of activation can be simplified. Therefore, the time required in the activation process of the in-vehicle device can be shortened. Therefore, excellent functionality regarding the transmission path in the in-vehicle network can be realized.

(9) A management method according to the embodiment of the present disclosure is performed in a management device, and includes the steps of: acquiring characteristic data indicating a characteristic of a transmission path in an in-vehicle network mounted to a vehicle; and transmitting, to the vehicle, deterioration change information corresponding to the acquired characteristic data, the deterioration change information indicating a change tendency of the characteristic of the transmission path due to aged deterioration of the transmission path.

In this method, deterioration change information corresponding to the characteristic of the transmission path in the vehicle is transmitted to the vehicle. Therefore, for example, in an in-vehicle device that performs the authentication process for the transmission path by using a comparison result between the characteristic of the transmission path in the past and the characteristic of the transmission path at present, when the authentication process has failed, it is possible to determine, by using the deterioration change information, whether or not the cause of the failure of the authentication process is aged deterioration of the transmission path. Therefore, excellent functionality regarding the transmission path in the in-vehicle network can be realized.

Hereinafter, an embodiment of the present disclosure will be described with reference to the drawings. In the drawings, the same or corresponding parts are denoted by the same reference signs, and descriptions thereof are not repeated. At least some parts of the embodiment described below can be combined together as desired.

### Configuration and Basic Operation

### Transmission Path Authentication System

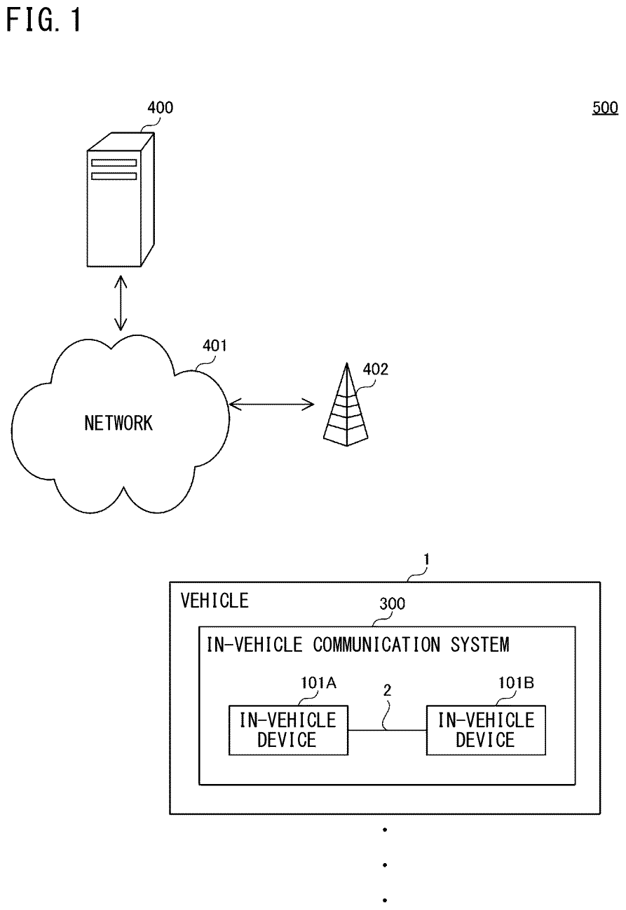

FIG. 1 shows a configuration of a transmission path authentication system according to an embodiment of the present disclosure. With reference to FIG. 1, a transmission path authentication system 500 includes a server 400, and one or a plurality of in-vehicle communication systems 300. The server 400 is an example of a management device.

The in-vehicle communication system 300 is mounted to a vehicle 1, and includes a plurality of in-vehicle devices 101. For example, the in-vehicle communication system 300 includes in-vehicle devices 101A, 101B as the in-vehicle device 101.

The in-vehicle device 101A and the in-vehicle device 101B are connected to each other through a transmission path 2. The in-vehicle device 101A and the in-vehicle device 101B can communicate with each other through the transmission path 2.

The transmission path 2 includes, for example, a connector that can be connected to the in-vehicle device 101A, a connector that can be connected to the in-vehicle device 101B, and a cable that can transmit various types of signals. The transmission path 2 is a differential transmission path, for example.

The in-vehicle communication system 300 may include three or more in-vehicle devices 101. In this case, for example, one in-vehicle device 101 in the in-vehicle communication system 300 is connected to a plurality of other in-vehicle devices 101 in the in-vehicle communication system 300 through corresponding transmission paths 2.

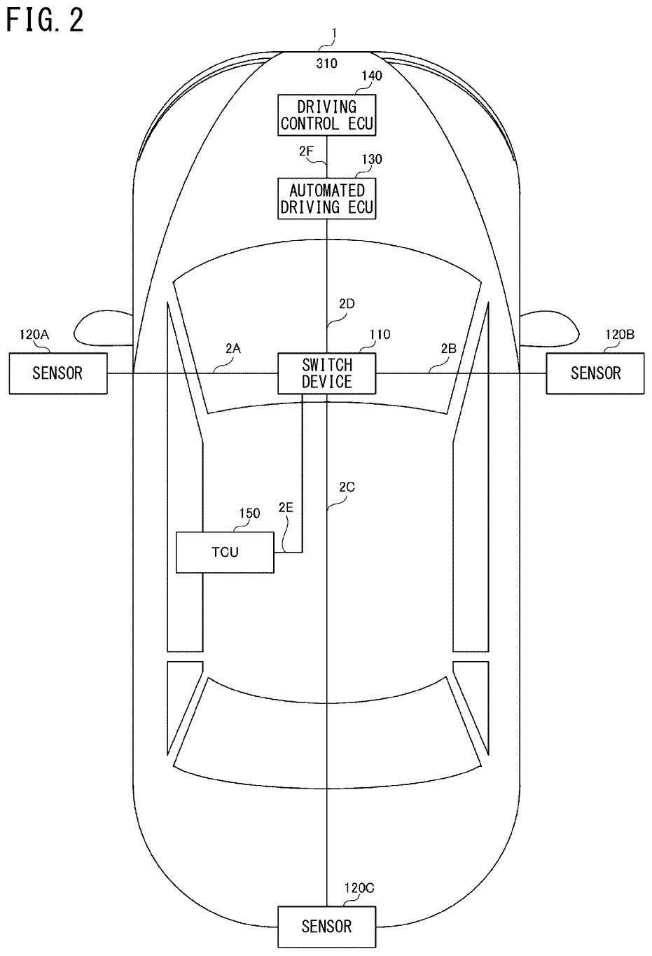

FIG. 2 shows an example of an in-vehicle network according to the embodiment of the present disclosure. With reference to FIG. 2, an in-vehicle network 310 includes a switch device 110, sensors 120A, 120B, 120C, an automated driving ECU (Electronic Control Unit) 130, a driving control ECU 140, and a TCU (Telematics Control Unit) 150. Hereinafter, each of the sensors 120A, 120B, 120C will also be referred to as a sensor 120. The in-vehicle network 310 is mounted to the vehicle 1.

The switch device 110, the sensors 120, the automated driving ECU 130, the driving control ECU 140, and the TCU 150 in the in-vehicle network 310 are examples of the in-vehicle device 101.

The TCU 150 can communicate with the server 400. Specifically, with reference to FIG. 1 and FIG. 2, the TCU 150 can communicate with the server 400 via a wireless base station device 402 and a network 401 by using an IP packet, for example.

More specifically, for example, when the TCU 150 has received, from the wireless base station device 402, a radio signal including an IP packet from the server 400, the TCU 150 acquires the IP packet from the received radio signal, stores the acquired IP packet into a frame, and transmits the frame to the switch device 110.

Meanwhile, when the TCU 150 has received a frame from the switch device 110, the TCU 150 acquires an IP packet from the received frame, causes the acquired IP packet to be included in a radio signal, and transmits the radio signal to the wireless base station device 402.

Upon receiving the radio signal from the TCU 150, the wireless base station device 402 acquires the IP packet from the received radio signal, and transmits the acquired IP packet to the server 400 via the network 401.

For example, the connection relationship between in-vehicle devices 101 after the in-vehicle devices 101 have been assembled to the vehicle 1 is fixed except when an external factor, such as a failure of the vehicle 1, an accident of the vehicle 1, or a physical unauthorized access to the in-vehicle network 310, has occurred. More specifically, the switch device 110 is connected to the sensor 120A, the sensor 120B, the sensor 120C, the automated driving ECU 130, and the TCU 150, through the respective transmission paths 2A, 2B, 2C, 2D, 2E which are each a transmission path 2. The automated driving ECU 130 is connected to the driving control ECU 140 through the transmission path 2F which is a transmission path 2.

In the in-vehicle network 310, data is transmitted and received through the transmission path 2 between in-vehicle devices 101. For example, in the in-vehicle network 310, transmission and reception of an Ethernet frame is performed between in-vehicle devices 101, according to the communication standard of IEEE802.3, through an Ethernet (registered trademark) cable, which is an example of the transmission path 2.

The in-vehicle network 310 may be configured such that transmission and reception of data is performed between in-vehicle devices 101, according to a communication standard such as CAN (Controller Area Network) (registered trademark), FlexRay (registered trademark), MOST (Media Oriented Systems Transport) (registered trademark), or LIN (Local Interconnect Network), other than the communication standard of IEEE802.3. That is, the transmission path 2 is not limited to an Ethernet cable, and may be a cable of another type. The transmission path 2 may be an optical fiber cable.

### Problem

With reference to FIG. 1 again, at the timing when, for example, an ignition power supply of the vehicle 1 has been turned on, each in-vehicle device 101 in the in-vehicle communication system 300 executes an activation process to establish communication connection with another in-vehicle device 101 connected through the transmission path 2.

More specifically, in the activation process, the in-vehicle device 101A and the in-vehicle device 101B transmit and receive a link pulse, which is a predetermined pulse signal, to recognize that the in-vehicle device 101A and the in-vehicle device 101B are in a state of being connected to each other through the transmission path 2.

Next, in the activation process, the in-vehicle device 101A and the in-vehicle device 101B determine: the transmission speed of communication between the in-vehicle device 101A and the in-vehicle device 101B; that the in-vehicle device 101A should operate as a master; and that the in-vehicle device 101B should operate as a slave.

Next, in the activation process, the in-vehicle device 101A and the in-vehicle device 101B perform link training, thereby setting a correction parameter CP to be used in correction of a communication signal between the in-vehicle device 101A and the in-vehicle device 101B. More specifically, the in-vehicle device 101B transmits a test signal, which is an analog signal having a predetermined time waveform, to the in-vehicle device 101A via the transmission path 2. The in-vehicle device 101A receives the test signal from the in-vehicle device 101B via the transmission path 2, and estimates the length of the transmission path 2, based on the time waveform of the received test signal. Then, based on the estimated length of the transmission path 2, the in-vehicle device 101A sets a correction parameter CP for reducing a BER (Bit Error Rate) to a predetermined value or lower, and stores the set correction parameter CP into a storage unit. In addition, the in-vehicle device 101A notifies the in-vehicle device 101B of the correction parameter CP via the transmission path 2. The in-vehicle device 101B stores the correction parameter CP notified of from the in-vehicle device 101A into a storage unit.

Then, the in-vehicle device 101A and the in-vehicle device 101B end the activation process, shift to a data mode, and perform transmission and reception of data, etc. When having received a signal from the in-vehicle device 101A in the data mode, the in-vehicle device 101B corrects the received signal by using the correction parameter CP. When having received a signal from the in-vehicle device 101B in the data mode, the in-vehicle device 101A corrects the received signal by using the correction parameter CP. Accordingly, variation, i.e., jitter, in the communication signal in the time axis direction can be reduced.

Meanwhile, in recent years, in association with enhancement of functionality of in-vehicle devices 101, the time required in the activation process of the in-vehicle devices 101 tends to increase. In particular, in an in-vehicle device 101 that has an OS (Operating System) mounted thereto, the time required in the activation process is long. In view of such a situation, a technology that can shorten the time required in the activation process of in-vehicle devices 101 is desired.

The transmission path authentication system 500 and the in-vehicle device 101 of the present disclosure solve the above problem by the configurations as described below.

### In-Vehicle Device

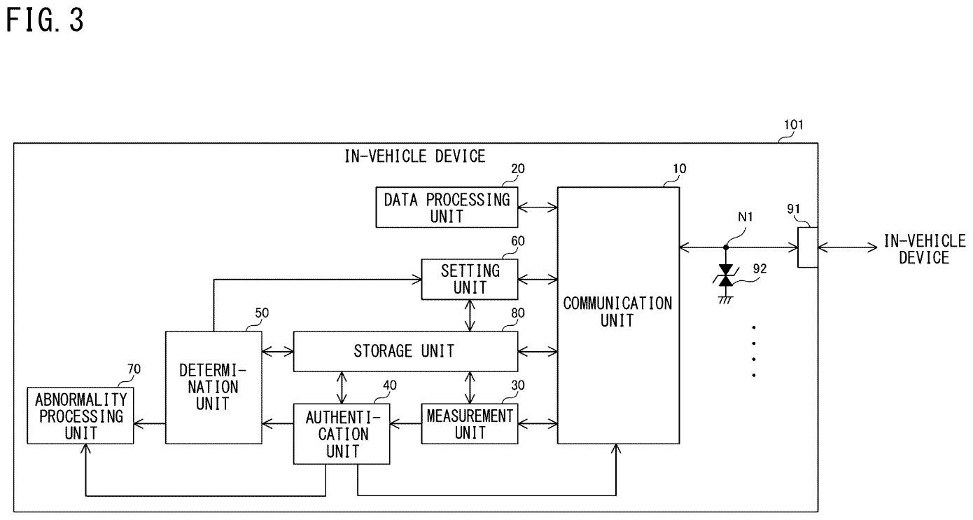

FIG. 3 shows a configuration of an in-vehicle device according to the embodiment of the present disclosure. With reference to FIG. 3, the in-vehicle device 101 includes a communication unit 10, a data processing unit 20, a measurement unit 30, an authentication unit 40, a determination unit 50, a setting unit 60, an abnormality processing unit 70, a storage unit 80, a communication port 91, and a front end circuit 92. The measurement unit 30 is an example of a measurement device. The authentication unit 40 is an example of an authentication device. The storage unit 80 is an example of a storage device.

A part or all of the communication unit 10, the data processing unit 20, the measurement unit 30, the authentication unit 40, the determination unit 50, the setting unit 60, and the abnormality processing unit 70 are realized by a circuitry including one or a plurality of processors, for example. The storage unit 80 is a flash memory included in the above circuitry, for example.

The communication port 91 is a terminal to which a cable serving as the transmission path 2 can be connected, for example. The front end circuit 92 is connected between a ground node and a node N1 between the communication port 91 and the communication unit 10. The front end circuit 92 is implemented by a bidirectional zener diode, for example. For example, the in-vehicle device 101 includes a plurality of the communication ports 91 and a plurality of the front end circuits 92, in accordance with the number of other in-vehicle devices 101 connected to the in-vehicle device 101 itself.

The data processing unit 20 generates a frame that is addressed to another in-vehicle device 101 and in which data that should be transmitted to the other in-vehicle device 101 is stored, and outputs the generated frame to the communication unit 10.

The communication unit 10 communicates with another in-vehicle device 101 through a transmission path 2. Specifically, the communication unit 10 transmits the frame received from the data processing unit 20, to an in-vehicle device 101 corresponding to the destination MAC (Media Access Control) address included in the frame, via a corresponding communication port 91.

More specifically, upon receiving the frame from the data processing unit 20, the communication unit 10 converts a bit string indicating the received frame into a symbol string in accordance with a predetermined modulation method. Then, starting from a symbol at the beginning in the converted symbol string, the communication unit 10 sequentially generates a communication signal having a level corresponding to the symbol, and transmits the generated communication signal to the other in-vehicle device 101 via the communication port 91 and the transmission path 2.

Meanwhile, the communication unit 10 receives a frame addressed to the in-vehicle device 101 to which the communication unit 10 belongs, through the communication port 91 from another in-vehicle device 101, and outputs the received frame to the data processing unit 20. More specifically, the communication unit 10 receives a communication signal from the other in-vehicle device 101 via the transmission path 2 and the communication port 91. The communication unit 10 generates a symbol string by demodulating the received communication signal in accordance with a predetermined modulation method, and converts the generated symbol string into a bit string, i.e., a frame. The communication unit 10 outputs the converted frame to the data processing unit 20.

Upon receiving the frame from the communication unit 10, the data processing unit 20 performs a predetermined process by using the received frame.

The measurement unit 30 measures a characteristic of the transmission path 2 in the in-vehicle network 310. More specifically, the measurement unit 30 measures a characteristic of the transmission path 2 that connects the in-vehicle device 101 that includes the measurement unit 30 and another in-vehicle device 101 to each other. As an example, the measurement unit 30 measures insertion loss IL in the transmission path 2 as the characteristic of the transmission path 2.

Specifically, in a state where termination processing has been performed in the in-vehicle device 101B, the measurement unit 30 in the in-vehicle device 101A transmits a plurality of signals for measurement having different frequencies, to the in-vehicle device 101B via the communication unit 10, the communication port 91, and the transmission path 2.

The in-vehicle device 101B measures the signals for measurement received from the measurement unit 30 in the in-vehicle device 101A, and transmits a response signal indicating the measurement result, to the in-vehicle device 101A.

Upon receiving the response from the in-vehicle device 101B via the transmission path 2, the communication port 91, and the communication unit 10, the measurement unit 30 in the in-vehicle device 101A measures the insertion loss IL in the transmission path 2 by using the received response signal and the signals for measurement transmitted by the measurement unit 30.

For example, after shipment of the vehicle 1, the measurement unit 30 measures the insertion loss IL in the transmission path 2 at a predetermined measurement trigger such as turning-on of an accessory power supply of the vehicle 1, turning-on of an ignition power supply of the vehicle 1, initialization of the in-vehicle device 101, configuration change of the in-vehicle network 310, or occurrence of a communication error in the in-vehicle network 310. Then, the measurement unit 30 outputs measurement information indicating the measurement result of the insertion loss IL in the transmission path 2, to the authentication unit 40. The measurement unit 30 may, after shipment of the vehicle 1, periodically measure the insertion loss IL in the transmission path 2 and output measurement information indicating the measurement result, to the authentication unit 40.

For example, the storage unit 80 stores characteristic data indicating the characteristic of the transmission path 2, and a correction parameter CP to be used, in communication with another in-vehicle device 101, by the communication unit 10.

More specifically, before shipment of the vehicle 1, the measurement unit 30 measures the insertion loss IL in the transmission path 2 when the in-vehicle communication system 300 has been assembled to the vehicle 1. Then, the measurement unit 30 stores the measurement result of the insertion loss IL in the transmission path 2 into the storage unit 80, as the characteristic data indicating the initial insertion loss IL in the transmission path 2.

When the characteristic data is stored into the storage unit 80 by the measurement unit 30 before shipment of the vehicle 1, the setting unit 60 sets a correction parameter CP by performing link training described above, and stores the set correction parameter CP into the storage unit 80.

More specifically, the setting unit 60 in the in-vehicle device 101A transmits a test signal request indicating that a test signal should be transmitted, to the in-vehicle device 101B via the communication unit 10, the communication port 91, and the transmission path 2. The in-vehicle device 101B receives the test signal request and transmits a test signal, which is an analog signal having a predetermined time waveform, to the in-vehicle device 101A. The setting unit 60 receives the test signal from the in-vehicle device 101B via the transmission path 2, the communication port 91, and the communication unit 10, estimates the length of the transmission path 2, based on the time waveform of the received test signal, and sets a correction parameter CP corresponding to the estimated length of the transmission path 2. The setting unit 60 stores the set correction parameter CP into the storage unit 80. The setting unit 60 notifies the in-vehicle device 101B of the correction parameter CP via the communication unit 10, the communication port 91, and the transmission path 2.

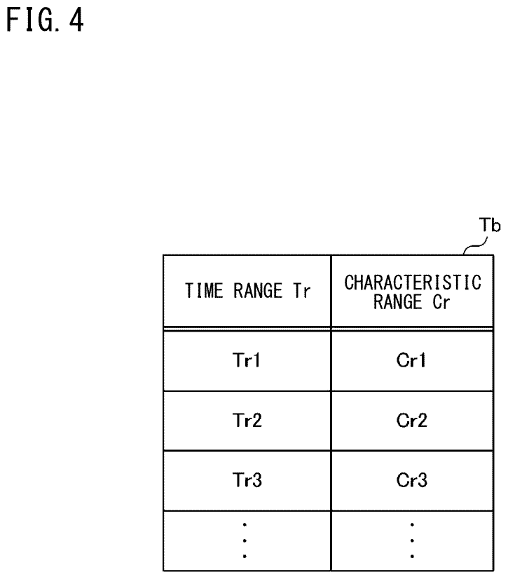

FIG. 4 shows an example of a deterioration prediction table stored in a storage unit in an in-vehicle device of the present disclosure. With reference to FIG. 4, the storage unit 80 stores a deterioration prediction table Tb indicating the change tendency of the characteristic of the transmission path 2 due to aged deterioration of the transmission path 2. The deterioration prediction table Tb is an example of deterioration change information. For example, the deterioration prediction table Tb is a table indicating the correspondence relationship between a time range Tr, which is the range of an elapsed time Ts from the time point of manufacture of the vehicle 1, and a characteristic range Cr, which is the range of the insertion loss IL.

More specifically, the communication unit 10 in an in-vehicle device 101 other than the TCU 150, when characteristic data has been stored into the storage unit 80 by the measurement unit 30, acquires the characteristic data from the storage unit 80. Then, the communication unit 10 generates a deterioration change information request including the acquired characteristic data, and transmits the generated deterioration change information request to the server 400 via the communication port 91, the transmission path 2, and the TCU 150.

The server 400 receives the deterioration change information request from the in-vehicle device 101, and transmits a deterioration prediction table Tb corresponding to the characteristic data included in the deterioration change information request, to the in-vehicle device 101 via the TCU 150, as a response to the deterioration change information request.

The communication unit 10 in the in-vehicle device 101 receives the deterioration prediction table Tb from the server 400 via the TCU 150, the transmission path 2, and the communication port 91, and stores the received deterioration prediction table Tb into the storage unit 80.

Meanwhile, the communication unit 10 in the TCU 150, when characteristic data has been stored into the storage unit 80 by the measurement unit 30, acquires the characteristic data from the storage unit 80. Then, the communication unit 10 generates a deterioration change information request including the acquired characteristic data, and transmits the generated deterioration change information request to the server 400 via the wireless base station device 402 and the network 401.

The server 400 receives the deterioration change information request from the TCU 150, and transmits a deterioration prediction table Tb corresponding to the characteristic data included in the deterioration change information request, to the TCU 150 via the network 401 and the wireless base station device 402, as a response to the deterioration change information request.

The communication unit 10 in the TCU 150 receives the deterioration prediction table Tb via the network 401 and the wireless base station device 402, and stores the received deterioration prediction table Tb into the storage unit 80.

The authentication unit 40 performs an authentication process for the transmission path 2 by using a comparison result between the characteristic data in the storage unit 80 and the measurement result by the measurement unit 30.

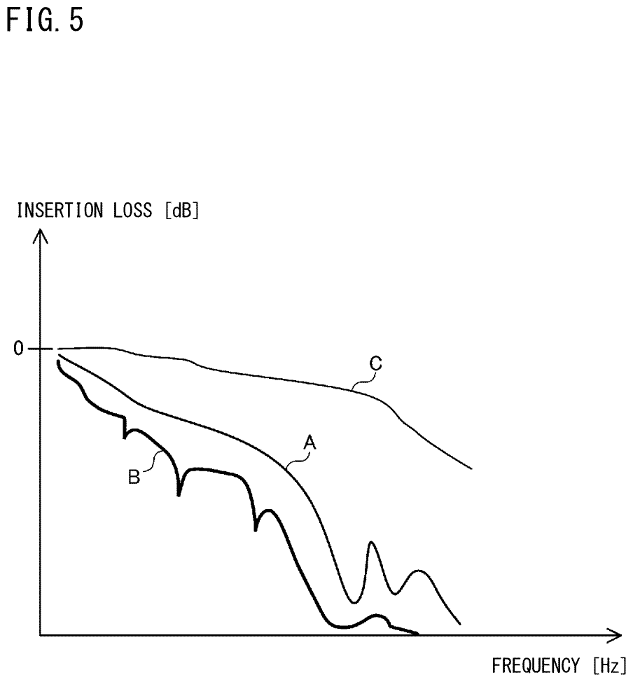

FIG. 5 shows an example of a measurement result of insertion loss in a transmission path in the in-vehicle communication system according to the embodiment the present disclosure. FIG. 5 shows a measurement result of the insertion loss IL in an Ethernet cable, which is an example of the transmission path. In FIG. 5, the vertical axis represents the insertion loss [dB] and the horizontal axis represents the frequency [Hz] of a signal for measurement.

With reference to FIG. 5, an insertion loss waveform A indicates the insertion loss IL in an Ethernet cable whose length is 10 m. An insertion loss waveform B indicates the insertion loss IL in an Ethernet cable whose length is 10 m and which is drawn alongside another Ethernet cable. An insertion loss waveform C indicates the insertion loss IL in an Ethernet cable whose length is 5 m.

Thus, the waveform of the insertion loss IL in the transmission path 2 differs according to the length and the wiring state of the transmission path 2. In addition, the waveform of the insertion loss IL in the transmission path 2 differs according to the manufacturer, the model number, and the like of the transmission path 2.

As described above, the connection relationship between in-vehicle devices 101 is fixed except when an external factor has occurred after the in-vehicle devices 101 have been assembled to the vehicle 1. Therefore, the authentication unit 40 can perform authentication of the transmission path 2 by comparing the initial insertion loss IL in the transmission path 2 and the current insertion loss IL in the transmission path 2.

With reference to FIG. 3 again, upon receiving measurement information from the measurement unit 30 after shipment of the vehicle 1, the authentication unit 40 acquires characteristic data from the storage unit 80. The authentication unit 40 calculates the difference between the insertion loss IL indicated by the characteristic data acquired from the storage unit 80 and the insertion loss IL indicated by the measurement information received from the measurement unit 30, and performs the authentication process for the transmission path 2 by using the calculated difference.

### Process Performed when Authentication Process has been Successful

For example, when the difference between the insertion loss IL indicated by the characteristic data and the insertion loss IL indicated by the measurement information is less than a predetermined threshold, the authentication unit 40 determines that no abnormality has occurred in the transmission path 2. Then, the authentication unit 40 outputs authentication success information indicating that the authentication of the transmission path 2 has been successful, to the communication unit 10 and the abnormality processing unit 70.

When the authentication process by the authentication unit 40 has been successful, the communication unit 10 performs, by using the correction parameter CP in the storage unit 80, correction of a reception signal received from another in-vehicle device 101 and correction of a transmission signal that should be transmitted to the other in-vehicle device 101.

More specifically, when having received authentication success information from the authentication unit 40, the communication unit 10 acquires the correction parameter CP from the storage unit 80 and retains the acquired correction parameter CP.

For example, the communication unit 10 has a compensation circuit such as a pre-emphasis circuit or a de-emphasis circuit. When having received a frame from the data processing unit 20, the communication unit 10 corrects the communication signal generated based on the received frame, by using the retained correction parameter CP, and transmits the corrected communication signal to the destination in-vehicle device 101 via the communication port 91 and the transmission path 2.

For example, the communication unit 10 has a compensation circuit such as an equalizer circuit or a DFE (Decision Feedback Equalizer) circuit. When having received a communication signal from another in-vehicle device 101, the communication unit 10 corrects the received communication signal, by using the retained correction parameter CP, and outputs the frame generated based on the corrected communication signal, to the data processing unit 20.

### Process Performed when Authentication Process has Failed

For example, when the difference between the insertion loss IL indicated by the characteristic data and the insertion loss IL indicated by the measurement information is equal to or larger than a predetermined threshold, the authentication unit 40 determines that an abnormality has occurred in the transmission path 2. Then, the authentication unit 40 outputs the measurement information and authentication failure information indicating that the authentication of the transmission path 2 has failed, to the determination unit 50 and the abnormality processing unit 70.

When the authentication process by the authentication unit 40 has failed, the abnormality processing unit 70 performs a predetermined abnormality process. For example, when having received authentication failure information from the authentication unit 40, the abnormality processing unit 70 performs a process, as the abnormality process, of notifying a user or a car dealer of the vehicle 1 that the authentication process for the transmission path 2 has failed. For example, as the abnormality process, the abnormality processing unit 70 generates communication path change information indicating that communication should be performed by using another transmission path 2 instead of the transmission path 2 for which the authentication process has failed, and outputs the generated communication path change information to the communication unit 10.

For example, when the authentication process by the authentication unit 40 has failed and the authentication process by the authentication unit 40 has been successful in the past, the abnormality processing unit 70 withholds the abnormality process. More specifically, when having received authentication failure information from the authentication unit 40 and having received authentication success information from the authentication unit 40 in the past, the abnormality processing unit 70 withholds the abnormality process.

The determination unit 50 determines, based on the measurement result by the measurement unit 30 and the deterioration prediction table Tb in the storage unit 80, whether or not the cause of the failure of the authentication process by the authentication unit 40 is aged deterioration of the transmission path 2. More specifically, when having received measurement information and authentication failure information from the authentication unit 40, the determination unit 50 acquires the deterioration prediction table Tb from the storage unit 80. In addition, the determination unit 50 acquires the elapsed time Ts from the time point of manufacture of the vehicle 1, from a timer (not shown).

With reference to FIG. 4 again, the determination unit 50 specifies a characteristic range Cr corresponding to the time range Tr in which the elapsed time Ts acquired from the timer is included, in the deterioration prediction table Tb acquired from the storage unit 80. The determination unit 50 confirms whether or not the insertion loss IL indicated by the measurement information received from the authentication unit 40 is included in the specified characteristic range Cr.

When the insertion loss IL indicated by the measurement information received from the authentication unit 40 is not included in the specified characteristic range Cr, the determination unit 50 determines that the cause of the failure of the authentication process by the authentication unit 40 is not aged deterioration of the transmission path 2. Then, the determination unit 50 outputs determination information indicating the determination result, to the abnormality processing unit 70.

The abnormality processing unit 70 receives the determination information from the determination unit 50 and performs the abnormality process described above.

Meanwhile, when the insertion loss IL indicated by the measurement information received from the authentication unit 40 is included in the specified characteristic range Cr, the determination unit 50 determines that the cause of the failure of the authentication process by the authentication unit 40 is aged deterioration of the transmission path 2. Then, the determination unit 50 outputs determination information indicating the determination result, to the setting unit 60.

When it has been determined, by the determination unit 50, that the cause of the failure of the authentication process is aged deterioration of the transmission path 2, the setting unit 60 sets a new correction parameter CP to be used, in communication with another in-vehicle device 101, by the communication unit 10.

More specifically, when having received determination information from the determination unit 50, the setting unit 60 sets a new correction parameter CP by performing link training, and stores the set correction parameter CP into the storage unit 80. In addition, the setting unit 60 outputs the set correction parameter CP to the communication unit 10.

The communication unit 10 receives the correction parameter CP from the setting unit 60 and retains the received correction parameter CP. The communication unit 10 performs correction of the communication signal by using the correction parameter CP.

### Server

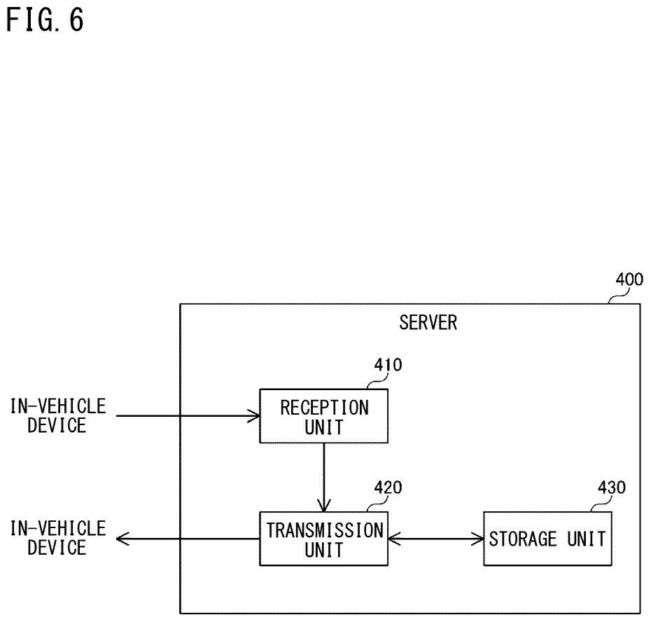

FIG. 6 shows a configuration of a server according to the embodiment of the present disclosure. With reference to FIG. 6, the server 400 includes a reception unit 410, a transmission unit 420, and a storage unit 430. The reception unit 410 is an example of an acquisition unit. A part or all of the reception unit 410 and the transmission unit 420 are realized by a circuitry including one or a plurality of processors, for example. The storage unit 430 is a flash memory included in the above circuitry, for example.

The reception unit 410 acquires characteristic data indicating the characteristic of the transmission path 2. More specifically, the reception unit 410 receives deterioration change information request from an in-vehicle device 101 via the wireless base station device 402 and the network 401. The reception unit 410 outputs the received deterioration change information request to the transmission unit 420.

The transmission unit 420 transmits a deterioration prediction table Tb corresponding to the characteristic data acquired by the reception unit 410, to the vehicle 1.

More specifically, the storage unit 430 stores a plurality of deterioration prediction tables Tb, and correspondence information indicating the correspondence relationship between the initial insertion loss IL of the transmission path 2 and the deterioration prediction table Tb.

Upon receiving the deterioration change information request from the reception unit 410, the transmission unit 420 refers to the correspondence information in the storage unit 430, and acquires, from the storage unit 430, a deterioration prediction table Tb corresponding to the insertion loss IL indicated by the characteristic data included in the received deterioration change information request. The transmission unit 420 transmits the acquired deterioration prediction table Tb to the transmission source in-vehicle device 101 of the deterioration change information request via the network 401 and the wireless base station device 402. As described above, the waveform of the insertion loss IL in the transmission path 2 differs according to the length, the wiring state, the manufacturer, the model number, and the like of the transmission path 2. By referring to the correspondence information in the storage unit 430, the transmission unit 420 can acquire, from the storage unit 430, the deterioration prediction table Tb corresponding to the length, the wiring state, the manufacturer, the model number, and the like of the transmission path 2, and transmit the deterioration prediction table Tb to the in-vehicle device 101.

For example, the deterioration prediction table Tb in the storage unit 430 is updated periodically or non-periodically by a manager of the server 400. After having transmitted the deterioration prediction table Tb to the in-vehicle device 101, if the deterioration prediction table Tb in the storage unit 430 has been updated, the transmission unit 420 transmits the updated deterioration prediction table Tb to the in-vehicle device 101 via the network 401 and the wireless base station device 402.

### Operation Flow

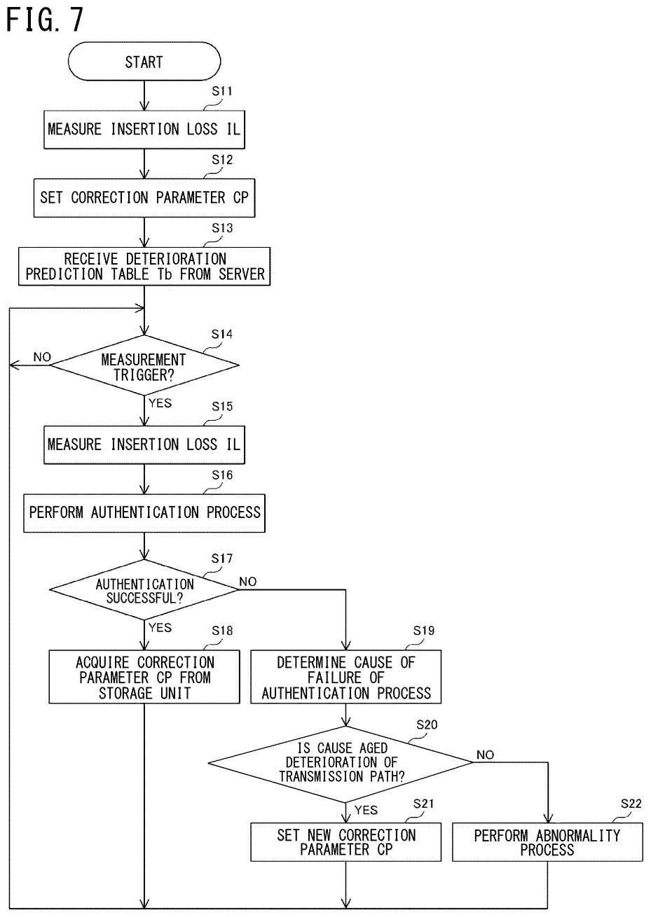

FIG. 7 is a flowchart describing an example of an operation procedure when an in-vehicle device performs the authentication process for a transmission path according to the embodiment of the present disclosure.

With reference to FIG. 7, first, before shipment of the vehicle 1, the in-vehicle device 101 measures the insertion loss IL in the transmission path 2 when the in-vehicle communication system 300 has been assembled to the vehicle 1, and stores the measurement result of the insertion loss IL in the transmission path 2 into the storage unit 80, as the characteristic data indicating the initial insertion loss IL in the transmission path 2 (step S11).

Next, the in-vehicle device 101 sets a correction parameter CP by performing link training, and stores the set correction parameter CP into the storage unit 80 (step S12).

Next, the in-vehicle device 101 transmits deterioration change information request including the characteristic data to the server 400, receives a deterioration prediction table Tb from the server 400, and stores the received deterioration prediction table Tb into the storage unit 80 (step S13).

Next, the in-vehicle device 101 waits for a predetermined measurement trigger such as turning-on of an accessory power supply of the vehicle 1 (NO in step S14), and when the measurement trigger has occurred (YES in step S14), measures the insertion loss IL in the transmission path 2 (step S15).

Next, the in-vehicle device 101 performs the authentication process for the transmission path 2 by using a comparison result between the characteristic data in the storage unit 80 and the measurement result of the insertion loss IL. More specifically, the difference between the insertion loss IL indicated by characteristic data and the insertion loss IL indicated by the measurement information is calculated, and the authentication process for the transmission path 2 is performed by using the calculated difference (step S16).

Next, when the authentication of the transmission path 2 has been successful, i.e., when it has been determined that no abnormality has occurred in the transmission path 2 (YES in step S17), the in-vehicle device 101 acquires the correction parameter CP from the storage unit 80. The in-vehicle device 101 corrects the communication signal by using the acquired correction parameter CP (step S18).

Next, the in-vehicle device 101 waits for a new measurement trigger (NO in step S14).

Meanwhile, when the authentication of the transmission path 2 has failed, i.e., when it has been determined that an abnormality has occurred in the transmission path 2 (NO in step S17), the in-vehicle device 101 determines, based on the measurement result of the insertion loss IL and the deterioration prediction table Tb in the storage unit 80, whether or not the cause of the failure of the authentication process is aged deterioration of the transmission path 2 (step S19).

Next, when it has been determined that the cause of the failure of the authentication process is aged deterioration of the transmission path 2 (YES in step S20), the in-vehicle device 101 sets a new correction parameter CP by performing link training, and stores the set correction parameter CP into the storage unit 80. The in-vehicle device 101 corrects the communication signal by using the new correction parameter CP (step S21).

Next, the in-vehicle device 101 waits for a new measurement trigger (NO in step S14).

Meanwhile, when it has been determined that the cause of the failure of the authentication process is not aged deterioration of the transmission path 2 (NO in step S20), the in-vehicle device 101 performs the abnormality process of, for example, notifying the user or the car dealer of the vehicle 1 that the authentication process for the transmission path 2 has failed (step S22).

Next, the in-vehicle device 101 waits for a new measurement trigger (NO in step S14).

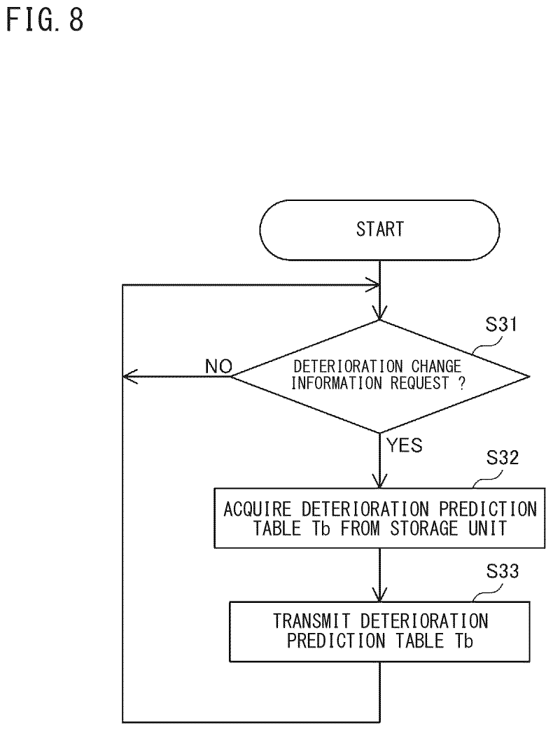

FIG. 8 is a flowchart describing an example of an operation procedure when the server performs transmission of a deterioration prediction table according to the embodiment of the present disclosure.

With reference to FIG. 8, first, the server 400 waits for arrival of a deterioration change information request (NO in step S31), and when having received a deterioration change information request from an in-vehicle device 101 via the wireless base station device 402 and the network 401 (YES in step S31), the server 400 acquires, from the storage unit 430, a deterioration prediction table Tb corresponding to the insertion loss IL indicated by the characteristic data included in the received deterioration change information request (step S32).

Next, the server 400 transmits the acquired deterioration prediction table Tb to the transmission source in-vehicle device 101 of the deterioration change information request via the network 401 and the wireless base station device 402 (step S33).

Next, the server 400 waits for arrival of a new deterioration change information request (NO in step S31).

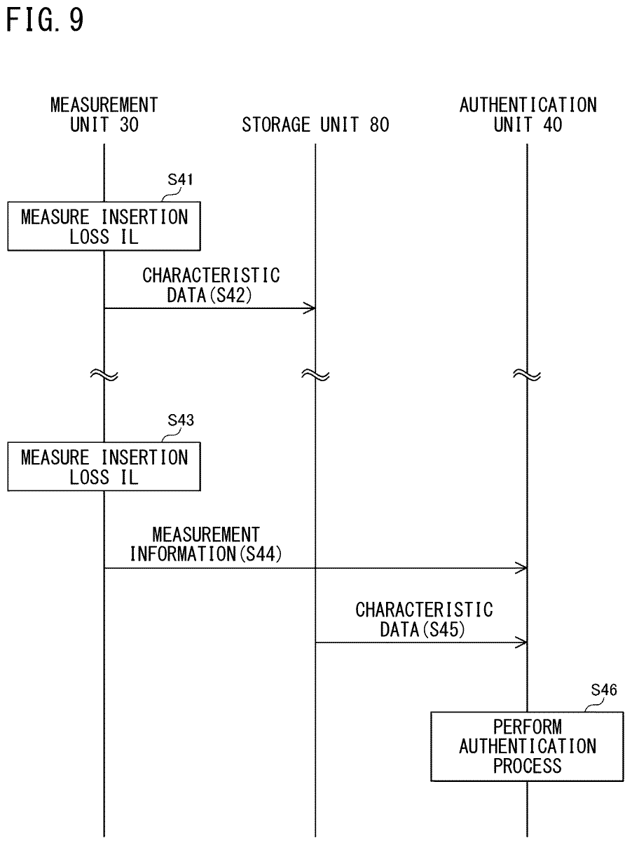

FIG. 9 shows an example of a sequence of the authentication process performed in the transmission path authentication system according to the embodiment of the present disclosure.

With reference to FIG. 9, first, before shipment of the vehicle 1, the measurement unit 30 measures the insertion loss IL in the transmission path 2 when the in-vehicle communication system 300 has been assembled to the vehicle 1 (step S41).

Next, the measurement unit 30 stores the measurement result of the insertion loss IL in the transmission path 2 into the storage unit 80, as the characteristic data indicating the initial insertion loss IL in the transmission path 2 (step S42).

Next, at a predetermined measurement trigger such as turning-on of an accessory power supply of the vehicle 1 after shipment of the vehicle 1, the measurement unit 30 measures the insertion loss IL in the transmission path 2 (step S43).

Next, the measurement unit 30 outputs measurement information indicating the measurement result of the insertion loss IL in the transmission path 2, to the authentication unit 40 (step S44).

Next, the authentication unit 40 receives the measurement information from the measurement unit 30, and acquires the characteristic data from the storage unit 80 (step S45).

Next, the authentication unit 40 calculates the difference between the insertion loss IL indicated by the characteristic data acquired from the storage unit 80 and the insertion loss IL indicated by the measurement information received from the measurement unit 30, and performs the authentication process for the transmission path 2 by using the calculated difference (step S46).

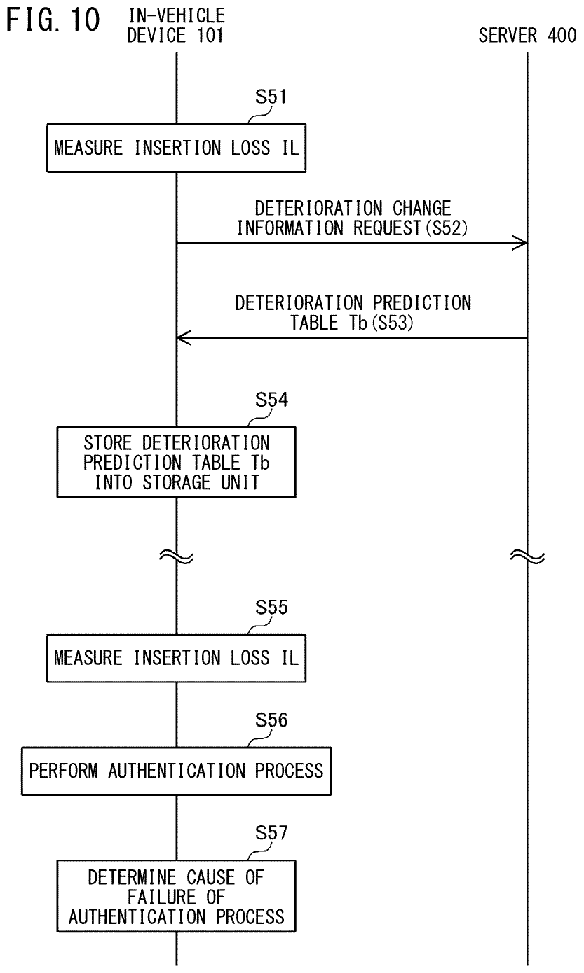

FIG. 10 shows an example of a sequence of the authentication process performed in the transmission path authentication system according to the embodiment of the present disclosure.

With reference to FIG. 10, first, before shipment of the vehicle 1, the in-vehicle device 101 measures the insertion loss IL in the transmission path 2 when the in-vehicle communication system 300 has been assembled to the vehicle 1 (step S51).

Next, the in-vehicle device 101 transmits a deterioration change information request including characteristic data indicating the measured insertion loss IL, to the server 400 (step S52).

Next, the server 400 receives the deterioration change information request from the in-vehicle device 101, acquires, from the storage unit 430, a deterioration prediction table Tb corresponding to the insertion loss IL indicated by the characteristic data included in the received deterioration change information request, and transmits the acquired deterioration prediction table Tb to the in-vehicle device 101 (step S53).

Next, the in-vehicle device 101 stores the deterioration prediction table Tb received from the server 400 into the storage unit 80 (step S54).

Next, at a predetermined measurement trigger such as turning-on of an accessory power supply of the vehicle 1 after shipment of the vehicle 1, the in-vehicle device 101 measures the insertion loss IL in the transmission path 2 (step S55).

Next, the in-vehicle device 101 performs the authentication process for the transmission path 2 by using a comparison result between the characteristic data in the storage unit 80 and the measurement result of the insertion loss IL (step S56).

Next, for example, when the authentication of the transmission path 2 has failed, the in-vehicle device 101 determines, based on the measurement result of the insertion loss IL and the deterioration prediction table Tb in the storage unit 80, whether or not the cause of the failure of the authentication process is aged deterioration of the transmission path 2. In accordance with the determination result, the in-vehicle device 101 performs the abnormality process or sets a new correction parameter CP (step S57).

In the transmission path authentication system 500 according to the embodiment of the present disclosure, the in-vehicle device 101 includes the authentication unit 40. However, the present disclosure is not limited thereto. The authentication unit 40 may be provided to a device external to the in-vehicle device 101.

In the transmission path authentication system 500 according to the embodiment of the present disclosure, the storage unit 80 in the in-vehicle device 101 stores the characteristic data. However, the present disclosure is not limited thereto. A storage unit provided to a device external to the in-vehicle device 101 may store the characteristic data. In this case, before shipment of the vehicle 1, the measurement unit 30 measures the insertion loss IL in the transmission path 2 when the in-vehicle communication system 300 has been assembled to the vehicle 1, and stores the measurement result of the insertion loss IL in the transmission path 2 into the storage unit via, for example a network, as the characteristic data indicating the initial insertion loss IL in the transmission path 2.

In the transmission path authentication system 500 according to the embodiment of the present disclosure, before shipment of the vehicle 1, the setting unit 60 in the in-vehicle device 101 sets a correction parameter CP by performing link training, and stores the set correction parameter CP into the storage unit 80. However, the present disclosure is not limited thereto. The setting unit 60 may, before shipment of the vehicle 1, download a correction parameter CP from the server 400 and store the correction parameter CP into the storage unit 80. Specifically, the storage unit 430 in the server 400 stores correspondence information indicating the correspondence relationship between the insertion loss IL in the transmission path 2 and the correction parameter CP. When characteristic data has been stored into the storage unit 80 by the measurement unit 30, the setting unit 60 downloads, from the server 400, a correction parameter CP corresponding to the insertion loss IL indicated by the characteristic data.

In the in-vehicle device 101 according to the embodiment of the present disclosure, the measurement unit 30 measures the insertion loss IL in the transmission path 2, as the characteristic of the transmission path 2. However, the present disclosure is not limited thereto. The measurement unit 30 may measure, for example, the characteristic impedance of the transmission path 2, the reflection loss in the transmission path 2, or the S-parameter of the transmission path 2, instead of the insertion loss IL in the transmission path 2.

For example, the measurement unit 30 measures the characteristic impedance in the transmission path 2 by using a technique according to TDR (Time Domain Reflectometry). Specifically, the measurement unit 30 outputs a signal for measurement such as a high-speed pulse signal or a step signal to the transmission path 2 via the communication unit 10 and the communication port 91, and receives a reflection signal with respect to the outputted signal for measurement via the communication unit 10 and the communication port 91. Then, based on the received reflection signal, the measurement unit 30 measures the characteristic impedance in the transmission path 2.

Before shipment of the vehicle 1, the measurement unit 30 measures the characteristic impedance of the transmission path 2 when the in-vehicle communication system 300 has been assembled to the vehicle 1, and stores the measurement result of the characteristic impedance of the transmission path 2 into the storage unit 80, as the characteristic data indicating the initial characteristic impedance of the transmission path 2. At a predetermined measurement trigger after shipment of the vehicle 1, the measurement unit 30 measures the characteristic impedance of the transmission path 2, and outputs measurement information indicating the measurement result to the authentication unit 40.

In the in-vehicle device 101 according to the embodiment of the present disclosure, the setting unit 60 sets a correction parameter CP by performing link training before shipment of the vehicle 1. However, the present disclosure is not limited thereto. For example, the storage unit 80 may store the correction parameter CP in advance before shipment of the vehicle. In this case, the setting unit 60 does not perform link training before shipment of the vehicle 1.

The setting unit 60 sets a new correction parameter CP by performing link training when the setting unit 60 has received determination information from the determination unit 50 after shipment of the vehicle 1. However, the present disclosure is not limited thereto. For example, the storage unit 80 may store a correction table indicating the correspondence relationship between the insertion loss IL and the correction parameter CP. In this case, without performing link training, the setting unit 60 acquires, from the correction table, a correction parameter CP corresponding to the insertion loss IL measured by the measurement unit 30 and outputs the acquired correction parameter CP to the communication unit 10.

In the in-vehicle device 101 according to the embodiment of the present disclosure, when the authentication process by the authentication unit 40 has been successful, the communication unit 10 performs, by using the correction parameter CP in the storage unit 80, correction of a reception signal received from another in-vehicle device 101, and correction of a transmission signal that should be transmitted to the other in-vehicle device 101. However, the present disclosure is not limited thereto. The communication unit 10 may perform, by using the correction parameter CP, either one of correction of a reception signal and correction of a transmission signal, or may be configured not to perform correction of a reception signal and correction of a transmission signal.

The in-vehicle device 101 according to the embodiment of the present disclosure includes the abnormality processing unit 70. However, the present disclosure is not limited thereto. The in-vehicle device 101 may be configured not to include the abnormality processing unit 70.

In the in-vehicle device 101 according to the embodiment of the present disclosure, when having received authentication failure information from the authentication unit 40 and having received authentication success information from the authentication unit 40 in the past, the abnormality processing unit 70 withholds the abnormality process. However, the present disclosure is not limited thereto. When having received authentication failure information from the authentication unit 40, the abnormality processing unit 70 may perform the abnormality process irrespective of whether or not the abnormality processing unit 70 has received authentication success information from the authentication unit 40 in the past.

The in-vehicle device 101 according to the embodiment of the present disclosure includes the determination unit 50. However, the present disclosure is not limited thereto. The in-vehicle device 101 may be configured not to include the determination unit 50.

The disclosed embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

Each process (each function) of the embodiment described above is realized by a circuitry including one or a plurality of processors. The above circuitry may be implemented by, for example, an integrated circuit in which one or a plurality of memories, various types of analog circuits, and various types of digital circuits are combined, in addition to the one or the plurality of processors. The one or the plurality of memories store programs (commands) to cause the one or the plurality of processors to execute each process. The one or the plurality of processors may execute each process in accordance with the programs read out from the one or the plurality of memories, or may execute each process in accordance with a logic circuit designed in advance so as to execute each process. The above processors may be various processors compatible with control of a computer, such as a CPU (Central Processing Unit), a GPU (Graphics Processing Unit), a DSP (Digital Signal Processor), an FPGA (Field Programmable Gate Array), and an ASIC (Application Specific Integrated Circuit). The plurality of processors that are physically separated from each other may execute each process in cooperation with each other. For example, the processors respectively mounted to a plurality of computers that are physically separated from each other may execute each process in cooperation with each other through a network such as a LAN (Local Area Network), a WAN (Wide Area Network), and the Internet. The program may be installed in the memory through the network from an external server device or the like, or may be distributed in a state of being stored in a storage medium such as a CD-ROM (Compact Disc Read Only Memory), a DVD-ROM (Digital Versatile Disk Read Only Memory), or a semiconductor memory, and installed from the storage medium into the memory.

The above description includes the features in the additional notes below.

### Additional Note 1

An in-vehicle device mounted to a vehicle, the in-vehicle device comprising:
a storage unit configured to store characteristic data indicating a characteristic of a transmission path in an in-vehicle network mounted to the vehicle;
a measurement unit configured to measure the characteristic of the transmission path; and
an authentication unit configured to perform an authentication process for the transmission path by using a comparison result between the characteristic data in the storage unit and a measurement result by the measurement unit, wherein
before shipment of the vehicle, the measurement unit measures the characteristic of the transmission path and stores a measurement result as the characteristic data into the storage unit,
after shipment of the vehicle, the measurement unit measures the characteristic of the transmission path at a predetermined measurement trigger, and
the authentication unit performs the authentication process by using a comparison result between the characteristic indicated by the characteristic data in the storage unit and the characteristic of the transmission path measured by the measurement unit at the measurement trigger.

### Additional Note 2

An in-vehicle device mounted to a vehicle, the in-vehicle device comprising:
a circuitry; and
a storage unit configured to store characteristic data indicating a characteristic of a transmission path in an in-vehicle network mounted to the vehicle, wherein
the circuitry
   measures the characteristic of the transmission path, and
   performs an authentication process for the transmission path by using a comparison result between the characteristic data in the storage unit and a measurement result of the characteristic of the transmission path.

### Additional Note 3

A management device comprising
a circuitry, wherein
the circuitry
   acquires characteristic data indicating a characteristic of a transmission path in an in-vehicle network mounted to a vehicle, and
   transmits, to the vehicle, deterioration change information corresponding to the acquired characteristic data, the deterioration change information indicating a change tendency of the characteristic of the transmission path due to aged deterioration of the transmission path.

### REFERENCE SIGNS LIST

1 vehicle
2 transmission path
10 communication unit
20 data processing unit
30 measurement unit
40 authentication unit
50 determination unit
60 setting unit
70 abnormality processing unit
80 storage unit
91 communication port
92 front end circuit
101, 101A, 101B in-vehicle device
110 switch device
120, 120A, 120B, 120C sensor
130 automated driving ECU
140 driving control ECU
150 TCU
300 in-vehicle communication system
310 in-vehicle network
400 server
401 network
402 wireless base station device
410 reception unit
420 transmission unit
430 storage unit
500 transmission path authentication system
N1 node
Tb deterioration prediction table

1. An in-vehicle device mounted to a vehicle, the in-vehicle device comprising:
a storage unit configured to store characteristic data indicating a characteristic of a transmission path in an in-vehicle network mounted to the vehicle;
a measurement unit configured to measure the characteristic of the transmission path; and
an authentication unit configured to perform an authentication process for the transmission path by using a comparison result between the characteristic data in the storage unit and a measurement result by the measurement unit.

2. The in-vehicle device according to claim 1, further comprising
a communication unit configured to communicate with another in-vehicle device through the transmission path, wherein
the storage unit further stores a correction parameter to be used, in communication with the other in-vehicle device, by the communication unit, and
when the authentication process by the authentication unit has been successful, the communication unit performs, by using the correction parameter in the storage unit, at least either one of correction of a reception signal received from the other in-vehicle device and correction of a transmission signal that should be transmitted to the other in-vehicle device.

3. The in-vehicle device according to claim 1, further comprising
an abnormality processing unit capable of performing a predetermined abnormality process when the authentication process by the authentication unit has failed.

4. The in-vehicle device according to claim 3, wherein
the abnormality processing unit withholds the abnormality process when the authentication process by the authentication unit has failed and the authentication process by the authentication unit has been successful in the past.

5. The in-vehicle device according to claim 2, wherein
the storage unit further stores deterioration change information indicating a change tendency of the characteristic of the transmission path due to aged deterioration of the transmission path, and
the in-vehicle device further comprises
a determination unit configured to determine, based on the measurement result by the measurement unit and the deterioration change information in the storage unit, whether or not a cause of failure of the authentication process is aged deterioration of the transmission path.

6. A management device comprising:
an acquisition unit configured to acquire characteristic data indicating a characteristic of a transmission path in an in-vehicle network mounted to a vehicle; and
a transmission unit configured to transmit, to the vehicle, deterioration change information corresponding to the characteristic data acquired by the acquisition unit, the deterioration change information indicating a change tendency of the characteristic of the transmission path due to aged deterioration of the transmission path.

7. A transmission path authentication system comprising:
a measurement device mounted to a vehicle;
an authentication device; and
a storage device, wherein
the storage device stores characteristic data indicating a characteristic of a transmission path in an in-vehicle network mounted to the vehicle,
the measurement device measures the characteristic of the transmission path, and
the authentication device performs an authentication process for the transmission path by using a comparison result between the characteristic data in the storage device and a measurement result by the measurement device.

8.-9. (canceled)

10. The in-vehicle device according to claim 2, further comprising
an abnormality processing unit capable of performing a predetermined abnormality process when the authentication process by the authentication unit has failed.

11. The in-vehicle device according to claim 5, further comprising
a setting unit configured to set a new correction parameter to be used, in communication with the other in-vehicle device, by the communication unit when it has been determined, by the determination unit, that the cause of the failure of the authentication process is aged deterioration of the transmission path.

12. The in-vehicle device according to claim 2, further comprising
a setting unit configured to set the correction parameter based on a length of the transmission path.

13. The in-vehicle device according to claim 12, wherein
the setting unit sets the correction parameter by performing a link training in an activation process of the in-vehicle device.

14. The in-vehicle device according to claim 12, wherein
the setting unit estimates the length of the transmission path based on a time waveform of a test signal received via the transmission path.

15. The in-vehicle device according to claim 12, wherein
the correction parameter is a parameter for reducing a BER in the transmission path to a specific value or lower.

16. The in-vehicle device according to claim 1, wherein
the characteristic includes insertion loss in the transmission path.

17. The in-vehicle device according to claim 16, wherein
the measurement unit measures the insertion loss based on a measurement signal transmitted by the in-vehicle device to an opposing device via the transmission path and a response signal received by the in-vehicle device from the opposing device via the transmission path.

18. The in-vehicle device according to claim 16, wherein
the authentication process is a process of comparing a first insertion loss in the transmission path indicated by the characteristic data and a second insertion loss measured by the measurement unit.

19. The in-vehicle device according to claim 18, wherein
when a difference between the first insertion loss and the second insertion loss is less than a threshold value, the authentication unit determines that the authentication process has been successful, and
when the difference between the first insertion loss and the second insertion loss is equal to or larger than the threshold value, the authentication unit determines that the authentication process has failed,

20. The in-vehicle device according to claim 1, wherein
before shipment of the vehicle, the measurement unit measures the characteristic of the transmission path and stores a measurement result as the characteristic data into the storage unit,
after shipment of the vehicle, the measurement unit measures the characteristic of the transmission path at a predetermined measurement trigger, and
the authentication unit performs the authentication process by using a comparison result between the characteristic indicated by the characteristic data in the storage unit and the characteristic of the transmission path measured by the measurement unit at the measurement trigger.
